(19) United States
(12) Patent Application Publication
(10) Pub. No.: US 2026/0186480 A1
(43) Pub. Date: Jul. 2, 2026

(54) Control Strategy for a Multi-Electrolyzer Module Matrix Control System

(71) Applicant: VERDE LLC, Stoughton, MA (US)

(72) Inventors: Haiming Li, Quincy, MA (US); Kangnan Zheng, Braintree, MA (US); Guangji Chen, Quincy, MA (US); Jiaxin Guo, Quincy, MA (US)

(21) Appl. No.: 19/006,671

(22) Filed: Dec. 31, 2024

(51) Int. Cl. G05B 23/02

(52) U.S. Cl. CPC G05B 23/0283; G05B 23/0224; G05B 23/027

(57) ABSTRACT

A multi-module matrix control system dynamically manages the operation of electrolyzers across modules to optimize power allocation and maximize efficiency. Each module operates as an independent unit with multiple electrolyzers and corresponding power sources, utilizing linear and nonlinear algorithms for load distribution. The system includes innovative rotation strategies to balance wear and ensure longevity, fault prediction for proactive maintenance, and real-time adjustments to adapt to power input fluctuations. With three operational modes—Peak Performance, Dynamic Equilibrium, and Energy Conservation—the system seamlessly transitions between states based on power availability. This control approach enhances hydrogen production scalability, minimizes energy consumption, and ensures stable, efficient operation under varying conditions, making it ideal for applications ranging from megawatt to gigawatt-scale systems.

### TECHNICAL FIELD

The present disclosure relates to the field of automatic control for water electrolysis hydrogen production, and more specifically, it relates to a power prediction array rotation control strategy and method for multiple electrolyzers.

### BACKGROUND OF THE INVENTION

In the current technological landscape, megawatt to gigawatt-scale multi-electrolyzer systems face several challenges and issues during hydrogen production. Firstly, energy consumption remains a critical factor constraining the efficiency and cost of hydrogen production. Traditional electrolyzer management strategies often fail to achieve optimal energy usage, resulting in energy waste and increased production costs.

Secondly, the stability and reliability of the system are also significant concerns. Multi-electrolyzer systems operating over extended periods may encounter equipment failures due to the lack of effective fault prediction and maintenance strategies. These failures not only affect production efficiency but also lead to increased maintenance costs.

Furthermore, the unpredictability of energy sources, such as fluctuations in power supply from the grid, wind, and solar energy, poses a challenge. Adjusting the operational status of electrolyzers in real time to accommodate these fluctuations while maintaining system efficiency and reducing energy consumption has become a pressing issue.

The existing technology lacks a solution that can flexibly and automatically manage the operation of multiple electrolyzers while optimizing energy consumption and enhancing system stability. Therefore, developing a new control strategy that enables efficient modular management of multi-electrolyzer systems, ensures stable system operation, and minimizes energy consumption is an essential innovation needed in the field of hydrogen production.

### Definitions

Electrolyzer: An apparatus configured to produce hydrogen through the electrolysis of water. Each electrolyzer operates either as an independent unit or as a component integrated within an electrolyzer module. The electrolyzer converts input current and voltage into hydrogen output under predefined operational parameters.

Electrolyzer Module: A structural unit comprising multiple electrolyzers and their associated power supply components. Each module possesses a specific power capacity and can function autonomously or in coordination with other modules within the system. Electrolyzer modules are the primary building blocks of the hydrogen production system described in this invention.

Control Unit: A core control component configured to monitor and manage real-time power supply from the grid, hydrogen production requirements, and the operational status of electrolyzers. The ICU dynamically adjusts power output and the operational states of electrolyzers to optimize energy utilization and system performance.

Power Prediction: A process involving the forecasting of power supply or demand using algorithms based on historical data and real-time inputs from the power grid. This invention employs power prediction to dynamically adjust the operational mode and load distribution of electrolyzer modules.

Array Rotation Control Strategy: A method designed to balance the operational wear and workload distribution of electrolyzers by periodically rotating the active configuration of electrolyzer modules. This strategy ensures equalized working hours and load sharing among electrolyzers, extending equipment lifespan and enhancing overall system stability.

Peak Performance Mode: An operational mode activated when the power supply from the grid exceeds a predetermined threshold. Under this mode, all electrolyzer modules are activated at full capacity to maximize hydrogen production.

Dynamic Equilibrium Mode: An operational mode used when the grid power supply is within a moderate range. In this mode, the system dynamically adjusts the number of active electrolyzer modules and their respective power outputs to maintain production efficiency while optimizing energy consumption.

Energy Conservation Mode: An operational mode triggered when the grid power supply falls below a defined threshold. In this mode, the system minimizes energy consumption by activating the minimum number of electrolyzer modules required to meet basic hydrogen production needs, ensuring equipment protection and operational stability.

Fault Prediction: A process of identifying potential equipment failures in advance by analyzing operational data, historical maintenance records, and real-time performance metrics of electrolyzers. The fault prediction process enables the system to estimate the time and nature of potential faults, allowing for proactive maintenance scheduling to reduce unexpected downtime.

Modular Design: A design methodology that structures the system into standardized, scalable units referred to as electrolyzer modules. This architecture facilitates flexibility, enhances scalability, and simplifies system maintenance, enabling the adjustment of production capacity based on variable hydrogen demand.

Power Input: The real-time power supplied to the system from the grid or alternative energy sources. Power input determines the operational mode of the system and governs the distribution of load across electrolyzer modules.

### SUMMARY OF THE INVENTION

The present invention introduces a power prediction and array rotation control strategy tailored for the efficient management of multiple electrolyzers. This strategy utilizes the total energy available from the power grid to optimize the operation of electrolyzer modules. By employing a function-based approach that combines hydrogen production requirements with electrolyzer power demands, the system determines the optimal number of electrolyzer modules to activate. Once activated, the power consumption of each electrolyzer within a module is calculated using a hydrogen production function that integrates both linear and nonlinear components. This approach is designed to minimize system operating costs, ensure smooth coordination of operations, and reduce the frequency of electrolyzer startups and shutdowns. To further enhance the system's performance and durability, the invention incorporates an innovative rotation mechanism, which adjusts the operational priority of electrolyzers during each startup and shut down cycle to extend the equipment lifespan.

The invention is grounded in several core principles that guide its design and functionality. These principles emphasize achieving high energy efficiency, ensuring safe production by avoiding low power operation levels such as 20% or 30% load wherever possible, and maintaining stable and reliable operation under various conditions. Building on these foundations, the invention also introduces a series of innovative features. One such feature is a real-time power adjustment mechanism that ensures electrolyzers operate at their optimal energy efficiency, based on continuous data analysis. Another key innovation is the array rotation control strategy, which periodically reconfigures the arrangement and combination of active electrolyzers to balance equipment wear and aging, thereby significantly extending the overall lifespan of the system. Additionally, the invention incorporates a comprehensive fault prediction and maintenance plan. By utilizing advanced monitoring and data analysis, this plan identifies potential equipment issues at an early stage, reducing unexpected downtime and minimizing maintenance costs.

In summary, this invention offers a highly efficient and reliable solution for managing the operation of multiple electrolyzers. It achieves an optimal balance between operational cost-effectiveness, system longevity, and performance stability, making it a robust choice for applications requiring precise and sustainable hydrogen production.

### BRIEF DESCRIPTION OF DRAWINGS

FIG. 1 illustrates the control system structure, highlighting the arrangement, logic, and functionality of each module, along with their individual components.

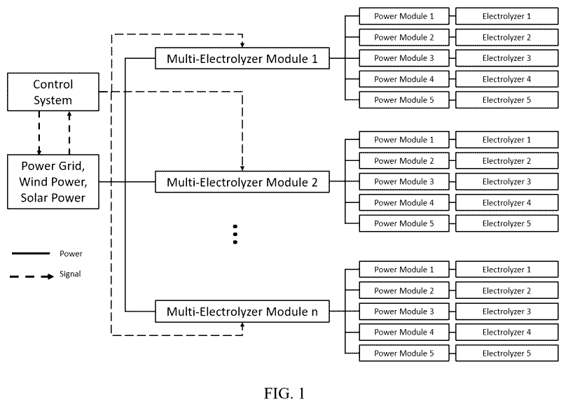

FIG. 2 illustrates the control strategy process, providing a detailed view of the operational flow and the coordination among the various system components.

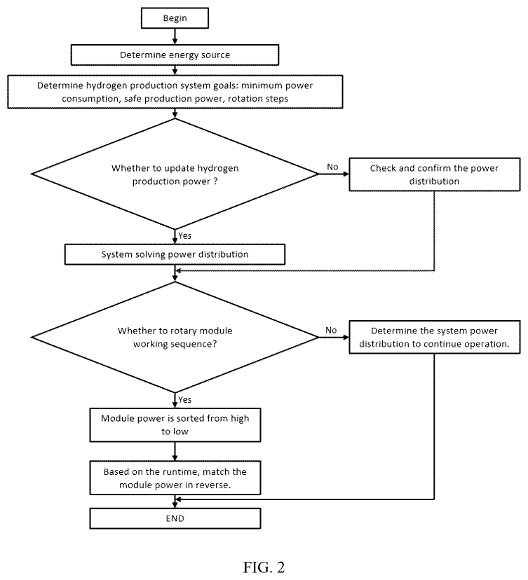

FIG. 3 illustrates the rotation matrix for a 25 MW module electrolyzer, explaining the sequential operation and its integration within the system.

FIG. 4 illustrates the multi-module control mode, outlining the management and synchronization of multiple modules to achieve cohesive operation.

FIG. 5 illustrates the power distribution within the linear module operating at 24.5 MW, showcasing the allocation and utilization of energy in this configuration.

FIG. 6 illustrates the power distribution in the non-linear module at 9 MW, focusing on the unique aspects of its energy management approach.

FIG. 7 illustrates the power distribution for the non-linear module at 4 MW, emphasizing its specific power allocation structure.

FIG. 8 illustrates the power distribution within the non-linear module operating at 3 MW, illustrating its energy distribution framework.

FIG. 9 illustrates the power distribution across a 90 MW multi-module system, emphasizing the integration and balance of power among the connected modules.

FIG. 10 illustrates the power distribution in a 50 MW multi-module system, focusing on the interaction, energy sharing, and overall efficiency of the connected modules.

FIG. 11 illustrates the power distribution in a 20 MW multi-module system, demonstrating the operational hierarchy and load-sharing mechanisms among its components.

### DETAILED DESCRIPTION OF THE INVENTION

### Module-Level Control Strategy

The module-level control strategy proposed in this invention employs an algorithm that integrates linear and nonlinear functions. The objective is to dynamically optimize load distribution and operational status of electrolyzers within a module based on real-time power input, thereby ensuring efficient power utilization and stable system operation.

The linear function control mechanism is applied when the power supply is sufficient, enabling the even distribution of input power across the electrolyzers in the module. This ensures that all activated electrolyzers operate at their efficient, full-load state. The power distribution rule is expressed as: Module power input

$${P}_{electrolyzer} = \frac{Module power input}{i}$$

where P_{electrolyzer} represents the power allocated to each electrolyzer, Module power input denotes the current available power input to the module, and i is the number of activated electrolyzers. This approach ensures that electrolyzers operate within their optimal performance range, significantly enhancing the energy efficiency of the module.

In contrast, the nonlinear function control mechanism is employed under conditions of insufficient or fluctuating power supply. This mechanism prioritizes essential production needs while progressively reducing the load on other electrolyzers. It incorporates a stepwise activation rule, which dictates that the first electrolyzer is activated when the module input power reaches 30% of its maximum power. Subsequent electrolyzers are activated only when the following condition is met:

$$Module power input \geq 0.4 ( i + 1 ) {P}_{electrolyzer , max}$$

where i represents the number of currently activated electrolyzers and P_{electrolyzer,max} is the maximum power of a single electrolyzer. Modules are activated only when the total input power satisfies the following condition:

$$Module power input \geq 0.3 {P}_{electrolyzer , max}$$

This rule ensures safe and stable operation, preventing damage to equipment due to inadequate power.

When total input power is insufficient to activate additional electrolyzers, the dynamic power allocation mechanism evenly distributes the available power among the activated electrolyzers, as shown in:

$${P}_{electrolyzer} = \frac{Module power input}{i}$$

This prioritizes the maintenance of basic operating requirements and prevents low-power conditions that could lead to equipment failure. When input power exceeds a certain threshold, allowing activated electrolyzers to operate at 40% power or more, any excess power is distributed linearly among the active electrolyzers, as described in:

$${P}_{electrolyzer} = 0.4 {P}_{electrolyzer , max} + \frac{Power input - 0.4 \cdot i \cdot {P}_{electrolyzer , max}}{i}$$

Where Power input denotes the current available power input to all modules.

To maintain operational continuity and stability, the system implements an optimized strategy for managing electrolyzer states under fluctuating power input. During power shortages, the system dynamically adjusts power distribution to ensure that the operating power of each active electrolyzer remains above 40% of its maximum capacity. When power input increases, the system prioritizes increasing the operating power of active electrolyzers until they reach full-load operation. Conversely, when power input decreases, the system reduces operating power sequentially, deactivating later activated electrolyzers first. This strategy minimizes start-stop cycles, enhancing production efficiency and reducing equipment wear.

Matrix-Based Rotation Strategy within a Module

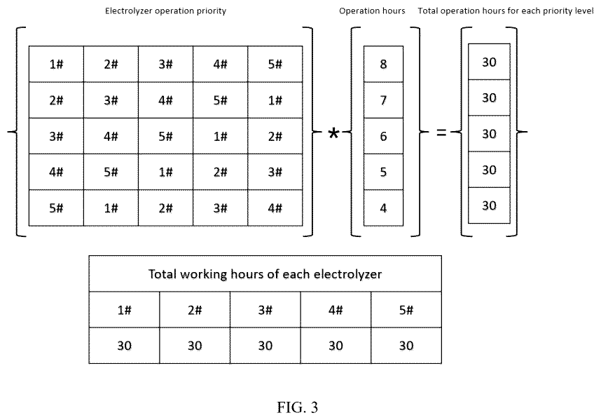

To balance workload, extend equipment lifespan, and maintain system stability, this invention introduces a matrix-based rotation strategy. By integrating a priority matrix, an operational time allocation vector, and a dynamic adjustment mechanism, the strategy ensures that cumulative operating times of all electrolyzers are evenly distributed over multiple cycles, as visualized in FIG. 3.

The priority matrix is established at the beginning of each rotation cycle and is denoted as A, an i×i matrix where i represents the number of electrolyzers in the module. Each row of the matrix corresponds to a rotation cycle, indicating the priority levels assigned to each electrolyzer. Each column represents the priority status of a specific electrolyzer across cycles. Using cyclic permutation principles, the matrix ensures that all electrolyzers are assigned high-priority roles an equal number of times over multiple cycles.

Based on the priority matrix, an operational time allocation vector B is defined. Each element of B corresponds to the operating hours allocated to a specific priority level. Higher-priority electrolyzers are assigned longer operating times, while lower-priority electrolyzers receive shorter durations. The total operating time for each electrolyzer during a rotation cycle is calculated using the equation:

$$C = A \cdot B$$

Where A is priority matrix, B is operational time vector, and C is total operating time vector for all electrolyzers. The resulting C vector reflects the total operating time of each electrolyzer for the current rotation cycle. Over multiple cycles, this ensures that the cumulative operating times of all electrolyzers gradually become balanced.

The system includes a dynamic adjustment mechanism to modify the priority matrix and operational time vector based on real-time production demands and the operational status of electrolyzers. If production demand increases, the system prioritizes activating more efficient electrolyzers or extending the operating time of high priority electrolyzers. Conversely, if an electrolyzer experiences faults or performance degradation, its priority is temporarily reduced to protect the equipment and redistribute the system load. This adaptability ensures efficient and stable performance under diverse operational scenarios.

### Detailed Description of Multi-Module Control Strategy

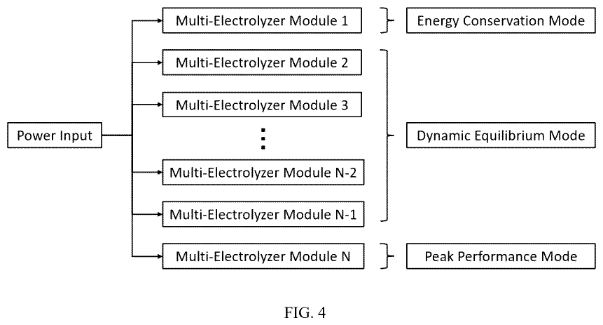

The multi-module control strategy in this invention dynamically monitors real-time grid power input through a control system. It selects one of three operational modes to ensure efficient operation, stable production, and optimized energy utilization under varying power conditions. The detailed strategy is described below, with reference to FIG. 4.

For the peak performance mode, the system enters Peak Performance Mode when the Power Input exceeds:

$$\frac{N - 1}{N} {P}_{module , max}$$

where N is total number of modules, and P_{module,max} is the full-load power capacity of a single module.

In this mode, all N modules are activated and operate at full load to maximize production efficiency. The power allocation for each module is given by:

$${P}_{module} = \frac{Power Input}{N}$$

This mode is applied when power input is abundant, prioritizing maximum resource utilization across all modules for peak production efficiency.

For dynamic equilibrium mode, the system enters dynamic equilibrium mode when the power input falls within the range:

$$\frac{1}{N} {P}_{module , max} to \frac{N - 1}{N} {P}_{module , max}$$

In this mode, the system dynamically adjusts the number of active modules M and redistributes power among them to optimize operating efficiency. The number of active modules is determined by:

$$M = \frac{Power Input}{{P}_{module , max}}$$

where M is rounded to the nearest whole number within the range of 2 to N−1, the power allocated to each active module is calculated as:

$${P}_{module} = \frac{Power Input}{M}$$

This mode is applied when the power input is insufficient to support all modules at full load. It ensures efficiency and stability by dynamically balancing the number of active modules and their power distribution.

For energy conservation mode, the system enters energy conservation mode when the power input falls below:

$$\frac{1}{N} {P}_{module , max}$$

In this mode, only one module is activated to meet minimal production requirements. The power allocated to the active module is equal to the total power input:

$${P}_{module} = Power Input$$

This mode is used under conditions of very low power input. It prioritizes basic production needs while minimizing energy consumption and reducing wear on equipment.

The control system dynamically switches between the three modes based on real-time power input:

Switching to Peak Performance Mode: When the input power exceeds the upper limit of dynamic equilibrium mode:

$$\frac{N - 1}{N} {P}_{module , max}$$

the system activates all modules and adjusts their power distribution to ensure full-load operation.
switching to dynamic equilibrium mode: when the input power drops below the lower limit of peak performance mode or rises above the upper limit of energy conservation mode:

$$\frac{1}{N} {P}_{module , max}$$

the system dynamically adjusts the number of active modules, gradually activating or deactivating modules to balance power distribution and maintain system efficiency.

Switching to energy conservation mode: when the input power falls below the lower limit of dynamic equilibrium mode

$$\frac{1}{N} {P}_{module , max}$$

the system reduces the active modules to one, ensuring basic production needs are met while conserving energy.

### Fault Prediction and Maintenance Module

The control system described in this invention includes a fault prediction and maintenance module that analyzes operational data from electrolyzers within each module. This module proactively identifies potential equipment issues, thereby reducing unexpected downtime and minimizing maintenance costs.

The fault prediction and maintenance module begin with data collection and monitoring, which involves the continuous gathering of real-time operational data from integrated detectors in each electrolyzer module. Key parameters monitored include voltage, current, temperature, and cumulative operational time. Voltage monitoring tracks variations in both input voltage and operating voltage of electrolyzers, while current monitoring records real-time load conditions. Temperature monitoring detects internal and ambient temperature fluctuations to ensure that all components operate within safe limits. Cumulative operational hours are also recorded to provide a foundation for maintenance planning. This data is collected via a sensor network and transmitted to a central workstation for analysis. The system ensures that the database is updated in real time, enabling comprehensive and accurate data availability for subsequent processing.

Following data collection, the module conducts data analysis and anomaly detection to identify trends or deviations from normal operating conditions. Acceptable ranges for key parameters, such as voltage and current thresholds, are predefined, and any deviation outside these ranges is flagged as an anomaly. Anomalies are detected through methods such as setting reference ranges for normal operation, correlating data points to identify sudden fluctuations or deviations, and comparing historical data with real-time measurements to recognize early signs of potential faults.

Based on these analytical results, the module incorporates a fault prediction mechanism that estimates the occurrence time of potential faults or evaluates the remaining operational lifespan of electrolyzers. Trend analysis is used to monitor gradual changes in voltage, current, or temperature, which may indicate an approaching fault. Additionally, cumulative operational hours and performance degradation curves are analyzed to estimate the remaining lifespan of electrolyzers. The system generates fault prediction reports that include the types of potential faults, their estimated occurrence times, deviations from the ideal operating state, and specific maintenance scheduling recommendations.

When a fault risk is detected, the module automatically triggers an alarm and generates actionable maintenance suggestions for operators. The alarm system displays real-time alerts on a visual interface and categorizes alarms into three levels: info, warning, and critical. This categorization allows operators to prioritize their responses. Remote notifications are also sent via email or mobile devices to inform the maintenance team promptly. Alongside the alarm, detailed maintenance instructions are provided, which may include recommendations for component replacement, parameter adjustments, or inspections of critical parts. The system optimizes maintenance schedules to reduce unplanned downtime and logs all maintenance actions for future reference, contributing to ongoing system improvements.

### EXAMPLES AND EMBODIMENTS

### Example 1: Control Methode for a 25 MW Module

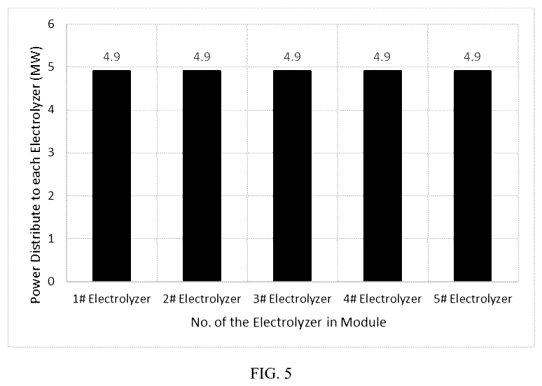

This control method is demonstrated using a 25 MW module composed of 5 electrolyzers, each with a maximum power capacity of 5 MW. The system dynamically adjusts the activation, power distribution, and operational state of the electrolyzers based on real-time power input. The following outlines the control strategies for input power levels of 24.5 MW, 9 MW, 4 MW, and 3 MW, as illustrated in FIG. 5 to FIG. 8.
Scenario 1: Input Power=24.5 MW (FIG. 5)
Startup Logic:
1st Electrolyzer: Activates at 1.5 MW (30% threshold) and increases to 2 MW (40% operational power).
2nd Electrolyzer: Activates when input power reaches 4 MW, increasing to 2 MW.
3rd Electrolyzer: Activates when input power reaches 6 MW, increasing to 2 MW.
4th Electrolyzer: Activates when input power reaches 8 MW, increasing to 2 MW.
5th Electrolyzer: Activates when input power reaches 10 MW, increasing to 2 MW.
Power Distribution:
Remaining power: 24.5−(5×2)=14.5 MW.

$$Pelectrolyzer = 2 + 14.5 / 5 = 4.9 MW$$

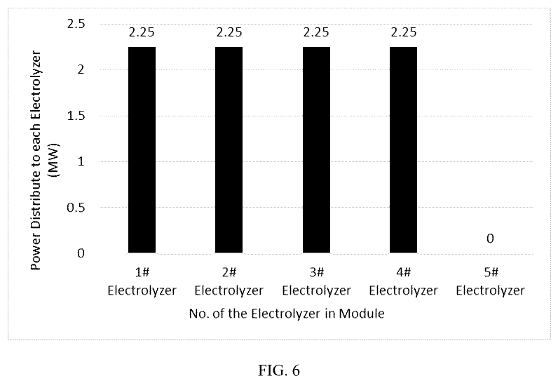

Result: Each electrolyzer operates at 4.9 MW.
Scenario 2: Input Power=9 MW (FIG. 6)
Startup Logic:
1st Electrolyzer: Activates and increases to 2 MW (40%).
2nd Electrolyzer: Activates when input power reaches 4 MW, increasing to 2 MW.
3rd Electrolyzer: Activates when input power reaches 6 MW, increasing to 2 MW.
4th Electrolyzer: Activates when input power reaches 8 MW, increasing to 2 MW.
5th Electrolyzer: Not activated due to insufficient input power.
Power Distribution:
Remaining power: 9−(4×2)=1 MW.

This remaining power is evenly distributed among the 4 active electrolyzers:

$$Pelectrolyzer = 2 + 1 / 4 = 2.25 MW$$

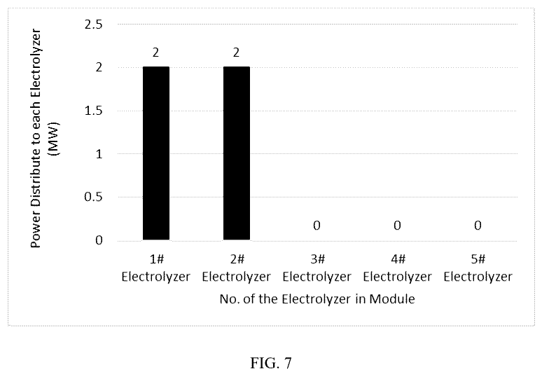

Result: Electrolyzers 1 through 4 operate at 2.25 MW; the 5th electrolyzer remains inactive.
Scenario 3: Input Power=4 MW (FIG. 7)
Startup Logic:
1st Electrolyzer: Activates and increases to 2 MW (40%).
2nd Electrolyzer: Activates when input power reaches 4 MW, increasing to 2 MW.
3rd Electrolyzer: Not activated due to insufficient input power.
Power Distribution:
Remaining power: 4−(2×2)=0 MW.

$$Pelectrolyzer = 2 MW$$

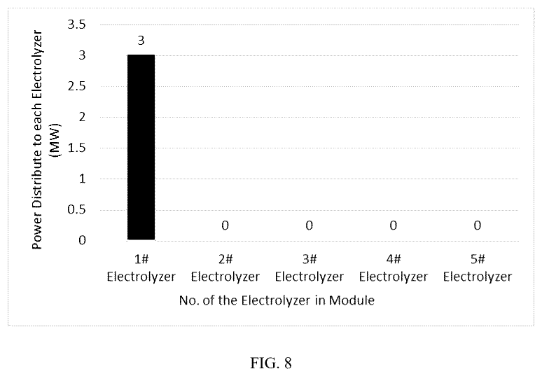

Result: Electrolyzers 1 and 2 each operate at 2 MW; remaining electrolyzers remain inactive.
Scenario 4: Input Power=3 MW (FIG. 8)
Startup Logic:
1st Electrolyzer: Activates and increases to 2 MW (40%).
2nd Electrolyzer: Not activated due to insufficient input power.
Power Distribution:
Remaining power: 3−2=1 MW.

This remaining power is allocated to the 1st electrolyzer:

$$Pelectrolyzer = 2 + 1 = 3 MW$$

Result: The 1st electrolyzer operates at 3 MW; remaining electrolyzers remain inactive.

### Examples 2: Multi-Module Control System with 4×25 MW Modules

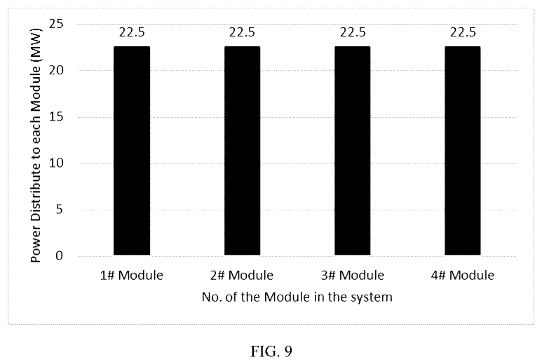

This example illustrates the operation of a 4-module system, each consisting of five electrolyzers with a total capacity of 100 MW. Based on real-time grid power input, the system dynamically selects one of three operational modes: Peak Performance Mode, Dynamic Equilibrium Mode, or Energy Conservation Mode. The transition between modes is demonstrated below.
Scenario 1: Input Power=90 MW, refer to FIG. 9 (Peak Performance Mode)
Activation Logic:

Per the Peak Performance Mode condition, when Power Input>(N−1)/N, with P system, max>¾*100=75 MW, activation occurs when Power Input>75 MW, all 4 modules are activated and operate at full capacity.

Each module receives:

$$P module = ( Power Input ) / N = 90 / 4 = 22.5 MW$$

Intra-Module Power Allocation:

Each module distributes power equally among its five electrolyzers:

$$Pelectrolyzer = {P}_{module} / 5 = 2 2.5 / 5 = 4.5 MW$$

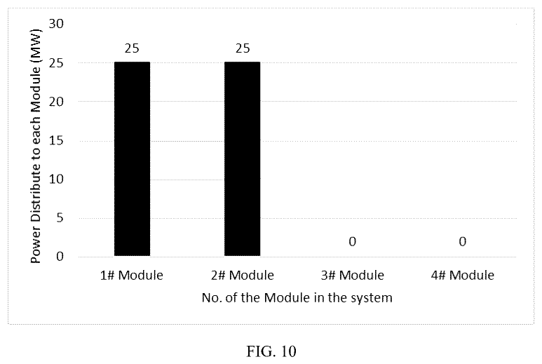

Result: All electrolyzers operate at 4.5 MW, close to maximum capacity, achieving the highest production efficiency.
Scenario 2: Input Power=50 MW, refer to FIG. 10 (Dynamic Equilibrium Mode)
Activation Logic:
Per the Dynamic Equilibrium Mode condition, when 1/N*P system, max<Power Input<(N−1)/N*P system, max, with 25 MW<Power Input<75 MW, the system adjusts the number of active modules dynamically.
Activated module count:

$$M = N * ( Power Input ) / {P}_{system , max} = 4 * 50 / 100 = 2$$

Module Power Distribution, each active module receives:

$$P module = ( Power Input ) / M = 50 / 2 = 25 MW$$

Intra-Module Power Allocation:
Within each active module:

Electrolyzers operate at 40% power (2 MW) initially, gradually activating subsequent electrolyzers.

All five electrolyzers in each module operate at full capacity:

$$Pelectrolyzer = P \_ module / 5 = 25 / 5 = 5 MW$$

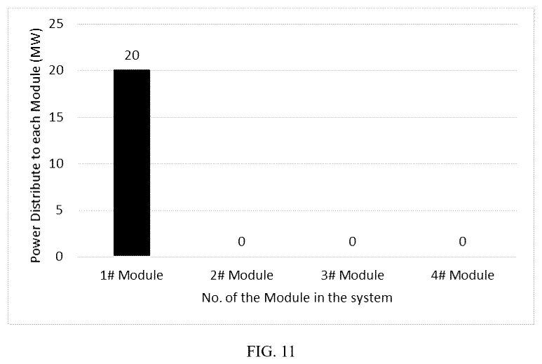

Result: Two modules are activated, with each electrolyzer operating at 5 MW, ensuring efficient operation under limited energy input.
Scenario 3: Input Power=20 MW, refer to FIG. 11 (Energy Conservation Mode)
Activation Logic:

Per the Energy Conservation Mode condition, when Power Input<1/N*P system, max=¼*100=25 MW, activation occurs when Power Input<25 MW, only one module is activated to meet basic production needs.
Module Power Distribution, the active module receives:

$$P module = Power Input = 20 MW$$

Intra-Module Power Allocation:
Electrolyzers activate sequentially:
1st Electrolyzer: Activates at 2 MW (40%).
2nd Electrolyzer: Activates at 4 MW (40% each for 2 electrolyzers).
3rd Electrolyzer: Activates at 6 MW (40% each for 3 electrolyzers).
4th Electrolyzer: Activates at 8 MW (40% each for 4 electrolyzers).
5th Electrolyzer: Activates at 10 MW (40% each for 5 electrolyzers).
Remaining power is equally distributed among the five electrolyzers:

$$Pelectrolyzer = ( Power Input ) / i = 20 / 5 = 4 MW$$

Result: One module operates, with all five electrolyzers running at 4 MW.

What is claimed is:

1. A multi-electrolyzer module matrix control system, comprising:
a plurality of modules, each module being configured as an independent unit comprising at least two electrolyzers and corresponding independent power supply components;
a control strategy for each module, wherein the power of each electrolyzer is controlled using linear and nonlinear algorithms to optimize performance and power allocation;
a rotation strategy for each module, wherein the system records the operational time of each electrolyzer and dynamically adjusts their operational status based on a priority matrix algorithm to balance operational times among the electrolyzers; and
a multi-module control strategy configured to dynamically adjust the load and operational status of each module based on real-time grid power input to optimize power distribution and ensure efficient system operation, further integrating a fault prediction and maintenance module.

2. The multi-electrolyzer module matrix control system according to claim 1, wherein the control strategy for a single module includes an algorithm combining linear and nonlinear functions to optimize power distribution, wherein linear function is applied under conditions of sufficient power supply, wherein the input power is evenly distributed among the active electrolyzers to achieve high-efficiency and full-load operation, defined by the formula:
$${P}_{electrolyzer} = \frac{Module power input}{i}$$
wherein Pelectrolyzer represents the power allocated to each electrolyzer, module power input is the total input power for the module, and i is the number of active electrolyzers.

3. The multi-electrolyzer module matrix control system according to claim 1, wherein the control strategy for a single module includes an algorithm combining linear and nonlinear functions to optimize power distribution, wherein nonlinear function is applied under conditions of insufficient or fluctuating power supply, prioritizing basic production needs and gradually reducing the load on other modules, comprising:
each module is activated only when the total input power meets the threshold of at least 30% of the maximum power of the first electrolyzer, and subsequent electrolyzers require at least 40% of their maximum power for activation to ensure safe operation. The activation condition is as follows:
$$Module power input \geq 0.3 \cdot {P}_{electrolyzer , max}$$
wherein Pelectrolyzer, max is the maximum power of a single electrolyzer; when the total input power is insufficient to activate the next electrolyzer, the current input power is evenly distributed among the already activated electrolyzers using the formula:
$${P}_{electrolyzer} = \frac{Module power input}{i}$$
when the input power is sufficient, and all activated electrolyzers have reached 40% power, the remaining power is linearly distributed across the activated electrolyzers as follows:
$${P}_{electrolyzer} = 0.4 \cdot {P}_{electrolyzer , max} + \frac{Remaining power}{i}$$
when the total input power is insufficient to activate new modules, the system maintains the current module operational state and optimizes power distribution among the active electrolyzers to ensure stability and efficient operation.

4. The matrix rotation strategy within a module according to claim 1, characterized by balancing the operational time of each electrolyzer, comprising:
establishing a priority matrix A of size i×i, where i represents the number of electrolyzers within the module, and the priority matrix specifies the operational priority of each electrolyzer during each rotation cycle, ensuring that the priorities of all electrolyzers are evenly distributed across cycles;
assigning an operational time vector B, wherein each element of the vector corresponds to the operational hours allocated to a specific priority level within a rotation cycle;
computing the total operational time vector C for all electrolyzers using matrix multiplication expressed as C=A×B, ensuring that the cumulative operational time of all electrolyzers is balanced over the rotation period;
dynamically adjusting the parameters of the priority matrix A and the operational time vector B at the end of each rotation cycle, wherein the adjustments are based on changes in production requirements and the operational status of the electrolyzers, thereby maintaining equipment stability and achieving a balanced distribution of workload among all electrolyzers over time.

5. The multi-module control strategy according to claim 1, characterized in that the control system dynamically selects one of the following operational modes based on real-time grid power input, wherein N represents the total number of modules:
peak performance mode, wherein when the grid power input exceeds (N−1/N)*P module, max, all modules are activated to operate at full load, maximizing production efficiency;
dynamic equilibrium mode, wherein when the grid power input is within the range of 1/N*P module, max to N−1/N*P module, max, the system dynamically adjusts the number of active modules and their power output, with the number of active modules ranging from 2 to N−1, optimizing energy utilization and maintaining stable operation;
energy conservation mode, wherein when the grid power input is less than 1/N*P module, max, only one module is activated to meet the minimal production demand, reducing energy consumption and protecting the equipment from excessive wear.

6. The system according to claim 1, characterized in that the control system includes a fault prediction and maintenance module configured to analyze operational data from the electrolyzers to identify potential equipment issues in advance, thereby reducing unexpected downtime and lowering maintenance costs, comprising:
data collection and monitoring, wherein critical operational data from each electrolyzer module is continuously collected and monitored via sensors, including but not limited to voltage, current, temperature, and cumulative operational time;
data analysis and anomaly detection, wherein acceptable ranges for monitored data are defined to identify abnormal fluctuations and trends that may indicate potential faults;
fault prediction, wherein data fluctuation trends are utilized to predict potential faults based on historical and real-time data, estimating the fault occurrence time or remaining service life and providing recommended maintenance schedules;
alarm and maintenance suggestion generation, wherein alarms are automatically triggered, and maintenance recommendations are generated when potential fault risks are detected, guiding operators to perform preventive maintenance actions proactively.
